(19) United States
(12) Patent Application Publication
(10) Pub. No.: US 2020/0060299 A1
(43) Pub. Date: Feb. 27, 2020

(54) METHODS FOR PROCESSING POULTRY THIGHS TO PRODUCE WING-LIKE POULTRY PARTS

(71) Applicant: David C. Pettinelli, Lugoff, SC (US)

(72) Inventor: David C. Pettinelli, Lugoff, SC (US)

(21) Appl. No.: 16/673,706

(22) Filed: Nov. 4, 2019

Related U.S. Application Data
(63) Continuation of application No. 15/013,640, filed on Feb. 2, 2016, now abandoned.
(60) Provisional application No. 62/187,542, filed on Jul. 1, 2015.

(51) Int. Cl. A22C 21/00; A23L 5/10; A23L 13/50; A23L 13/00

(52) U.S. Cl. CPC A22C 21/0076; A23L 5/11; A23V 2002/00; A23L 13/03; A23L 13/57

(57) ABSTRACT

Methods for processing poultry food products are provided, more particularly methods for processing poultry thighs to produce wing-like poultry parts. The poultry parts comprise a skin-on bone-in thigh portion and/or a skin-on boneless thigh portion. The food products approximate the texture and eating experience of traditional poultry wings with the enhanced flavor and juiciness of dark meat. Also provided are food product packages comprising the skin-on thigh portions.

### CROSS-REFERENCE TO RELATED APPLICATION

This application claims priority to U.S. Provisional Application No. 62/187,542 filed Jul. 1, 2015, the disclosure of which is herein incorporated by reference in its entirety for all purposes.

### TECHNICAL FIELD

The present invention relates generally to methods for processing poultry food products, and more particularly to methods for processing poultry thighs to produce wing-like poultry parts.

### BACKGROUND

Poultry products, such as chicken and turkey, include “white meat” and “dark meat,” with white meat generally located in the breast and wings, and dark meat generally located in the legs and thighs. White meat is derived from white muscle fibers that are adapted to produce short bursts of power. White muscle fibers rely on anaerobic respiration and use glycogen as a fast energy source. By contrast, dark meat is made up of red muscle fibers that are adapted for regular and continuous use. Red muscle fibers rely on aerobic respiration and have a relatively large number of capillaries, which provide the tissue with oxygen but also give it a deep color and rich flavor.

Many consumers tend to prefer white poultry meat over dark meat. One reason for this preference is that the texture of dark meat, which typically has more fat and connective tissue, is considered less appealing than the more consistent texture of white meat. This is in spite of the fact that the lower fat content of white meat tends to produce dryer cooked product as compared to dark meat.

U.S. Pat. No. 5,297,984 discloses a method of making a food product from the leg of a bird wherein the leg has a thigh end, a foot end, an elongated bone extending generally from the thigh end to the foot end, and meat surrounding and attached to the bone. The method comprises the steps of severing at least a first portion of the meat from the bone proximate the thigh end while leaving a second portion of the meat distal from the thigh end attached to the bone. The first portion of the meat is moved toward the foot end to expose a portion of the bone at least proximate the thigh end. At least part of the exposed portion of the bone is severed and removed. The first portion of the meat is then moved toward the thigh end so that the first portion of the meat extends outwardly from the remaining part of the bone to provide a leg food product which is boneless at its thigh end and includes a bone at its foot end.

U.S. Pat. No. 6,428,838 discloses a method of making a “fun to eat food product.” The fun to eat food product is formed from an animal's thigh, including a thigh bone having a first end and a second end. The thigh is partially deboned, thigh causing the first end of the thigh bone to extend from the thigh meat to form a handle for holding the food product. The thigh meat is generally positioned proximate to the second end of the thigh bone after the partial deboning.

U.S. Pat. No. 7,008,313 discloses a method of cutting the thigh of a bird to form a boneless thigh meat product. After the bone has been removed from the thigh, the “thin muscle” of the thigh is removed from the “thick muscle” by cutting entirely through the meat along the path of the removed bone. Next, the “red muscle” of the thigh is removed from the thick muscle by making a second cut which is parallel to the top surface of the thick muscle. Additional cuts are made in order to provide equally sized strips of the thick muscle.

U.S. Patent Application Pub. No. 20140272008 discloses a method for preparing a boneless thigh meat poultry product from a poultry thigh comprising: making one or more cuts of the meat at the inner side of the thigh substantially along the longitudinal axis of the bone, wherein the one or more cuts cause a first edge of the meat and a second edge of the meat to separate from each other. One or more additional cuts of the meat are made to detach the bone from the meat. The first edge and the second edge are spread apart from one another in a substantially lateral direction away from the longitudinal axis of the bone. One or more cuts of the meat are made at the outer side of the thigh along a first interface between a center portion and a left portion sufficient to separate the center portion from the left portion. One or more cuts of the meat are made at the outer side of the thigh along a second interface between the center portion and a right portion sufficient to separate the center portion from the right portion.

The examples described above are indicative of the consumer's desire to see new and different product forms for traditional poultry parts such as thighs. Accordingly, there is a need for new methods for preparing poultry parts such as thighs to address consumer textural preferences while retaining the enhanced flavor and juiciness of dark meat compared to white meat.

### SUMMARY

To address the foregoing problems, in whole or in part, and/or other problems that may have been observed by persons skilled in the art, the present disclosure provides compositions and methods as described by way of example as set forth below.

In one embodiment, a method for preparing thigh portion poultry products from a poultry thigh is provided, the method comprising the steps of: a) providing a poultry thigh comprising skin, meat, and a generally centrally located bone; b) making one or more cuts substantially alongside and substantially parallel to the bone to produce a skin-on bone-in thigh portion and a skin-on boneless thigh portion; c) preparing the skin-on bone-in thigh portion and/or the skin-on boneless thigh portion for cooking comprising flattening the skin of each thigh portion against the meat of each thigh portion; d) cooking the skin-on bone-in thigh portion and/or the skin-on boneless thigh portion to an internal temperature of at least about 120° F.; and e) cooling the skin-on bone-in thigh portion and/or the skin-on boneless thigh portion at a temperature of at most about 40° F. for between about 45 minutes and 75 minutes, wherein the skin of each of the skin-on bone-in thigh portion and/or the skin-on boneless thigh portion is maintained in a position such that it is substantially flat against the meat of each thigh portion. In another embodiment, the method further comprises the step of: f) frying the skin-on bone-in thigh portion and/or the skin-on boneless thigh portion to an internal temperature of at least 165° F. In a particular embodiment, step (f) comprises deep frying at about 350° F. for between about 120 seconds and about 180 seconds. In another particular embodiment, step (d) comprises baking at about 350° F. for about 50 minutes. In another particular embodiment, the poultry thigh is a chicken thigh.

In another embodiment, a skin-on bone-in thigh portion and/or a skin-on boneless thigh portion is provided produced by the method steps (a) through (e). In a further embodiment, a package is provided comprising at least one skin-on bone-in thigh portion and/or at least one skin-on boneless thigh portion produced by the method steps (a) through (e). In a particular embodiment, the package comprising at least one skin-on bone-in thigh portion and/or at least one skin-on boneless thigh portion produced by the method steps (a) through (e) further comprises a marinade.

In another embodiment, a breaded skin-on bone-in thigh portion and/or a skin-on boneless thigh portion is provided, wherein a bone-in thigh portion and/or a skin-on boneless thigh portion produced by the method steps (a) through (e) is substantially coated in breading. In a further embodiment, a package is provided comprising at least one breaded skin-on bone-in thigh portion and/or at least one breaded skin-on boneless thigh portion produced by the method steps (a) through (e).

In another embodiment, a skin-on bone-in thigh portion and/or a skin-on boneless thigh portion is provided produced by the method steps (a) through (f). In a further embodiment, a package is provided comprising at least one skin-on bone-in thigh portion and/or at least one skin-on boneless thigh portion produced by the method steps (a) through (f).

Other compositions, methods, features, and advantages of the invention will be or will become apparent to one with skill in the art upon examination of the following figures and detailed description. It is intended that all such additional compositions, methods, features, and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 depicts a top view of the outer side of a skin-on and bone-in chicken thigh;

FIG. 2 depicts a top view of the inner side of the chicken thigh shown in FIG. 1, in which one or more cuts are made substantially alongside and substantially parallel to the bone;

FIG. 3 depicts a top view of the inner side of the chicken thigh shown in FIG. 2, in which one or more cuts are made substantially alongside and substantially parallel to the bone, thereby producing a bone-in thigh portion and a skin-on boneless thigh portion;

FIG. 4 depicts a top view of the outer side of the skin-on bone-in thigh portion and the skin-on boneless thigh portion;

FIG. 5 depicts a top view of the inner side of the skin-on bone-in thigh portion and the skin-on boneless thigh portion;

FIG. 6 depicts a top view of the outer side of the chicken thigh portions shown in FIG. 4, in which the skin of each thigh portion is substantially flat against the meat of each thigh portion;

FIG. 7 depicts a top view of the outer side of the chicken thigh portions shown in FIG. 6 after the chicken thigh portions have been cooked to an internal temperature of at least about 120° F. and then cooled at a temperature of at most about 40° F. for about an hour; and.

FIG. 8 depicts a top view of the outer side of the chicken thigh portions shown in FIG. 7 after the chicken thigh portions have been fried to an internal temperature of at least 165° F.

### DETAILED DESCRIPTION

In recent years, there has been an increasing demand for innovative meat products, particularly products comprising “finger food” such as hot wings and buffalo wings. Furthermore, many consumers tend to prefer white poultry meat over dark meat in spite of the fact that the lower fat content of white meat tends to produce dryer cooked product as compared to dark meat. One reason for this preference is that the texture of dark meat, which typically has more fat and connective tissue, is considered less appealing than the more consistent texture of white meat.

The present invention comprises a method of making unique food products from poultry thighs. The food products approximate the texture and eating experience of traditional poultry wings with the enhanced flavor and juiciness of dark meat.

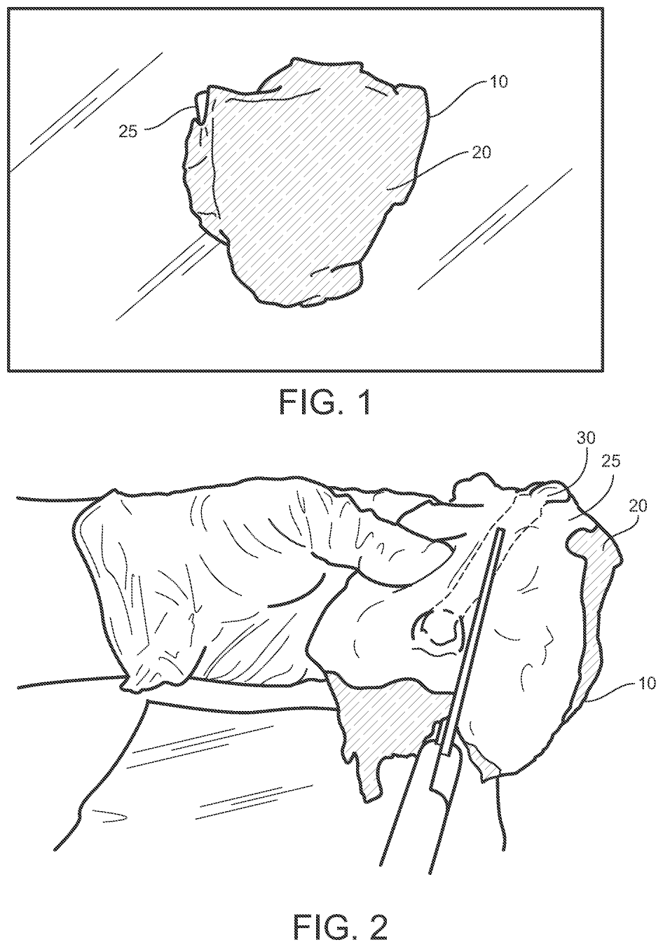

Referring to the drawings in detail wherein like numerals indicate like elements throughout the figures, there is shown in FIG. 1 a top view of the outer side of a skin-on and bone-in chicken thigh 10. As shown in FIG. 1, the chicken thigh 10 comprises skin 20 and meat 25. Although in the presently described embodiments a chicken thigh 10 is employed for illustrating the present invention, one skilled in the art will understand that the present invention is equally applicable to any other poultry, fowl, or any other birds or the like.

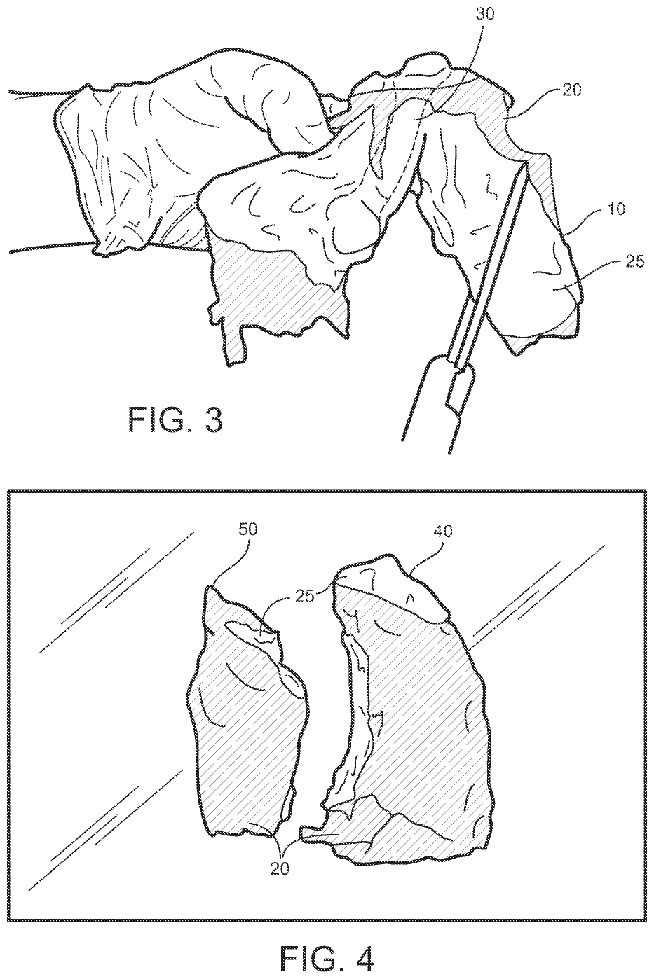

As shown in FIG. 2 and FIG. 3, the chicken thigh 10 comprises skin 20, meat 25, and a generally centrally located bone 30. The first step in the present embodiment is to make one or more cuts substantially alongside and substantially parallel to the bone 30.

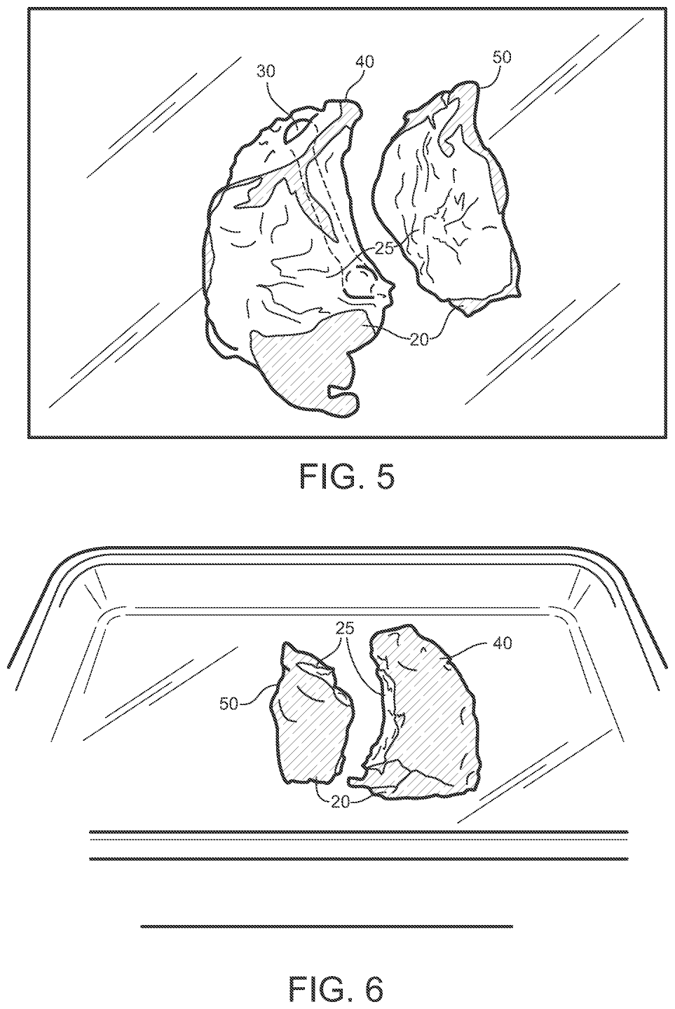

As shown in FIG. 4 and FIG. 5, the one or more cuts made substantially alongside and substantially parallel to the bone 30 produce a skin-on bone-in thigh portion 40 and a skin-on boneless thigh portion 50 (i.e., each of the thigh portions comprise skin 20 and meat 25). FIG. 4 depicts a top view of the outer sides of the skin-on bone-in thigh portion 40 and the skin-on boneless thigh portion 50. FIG. 5 depicts a top view of the inner side of the skin-on boneless thigh portion 50 and the skin-on bone-in thigh portion 40 comprising the bone 30.

As shown in FIG. 6, the skin 20 of each of the skin-on bone-in thigh portion 40 and the skin-on boneless thigh portion 50 is substantially flat against the meat 25 of each thigh portion. The skin-on bone-in thigh portion 40 and/or the skin-on boneless thigh portion 50 are then cooked to an internal temperature of at least about 120° F. In some embodiments, the skin-on bone-in thigh portion 40 and/or the skin-on boneless thigh portion 50 are cooked to an internal temperature of at least about 125° F., at least about 130° F., or at least about 135° F. In other embodiments, the skin-on bone-in thigh portion 40 and/or the skin-on boneless thigh portion 50 are cooked to an internal temperature of between about 120° F. to about 140° F. In another embodiment, cooking the skin-on bone-in thigh portion 40 and/or the skin-on boneless thigh portion 50 comprises baking the thigh portions, particularly where the thigh portions are baked at about 350° F. for about 50 minutes.

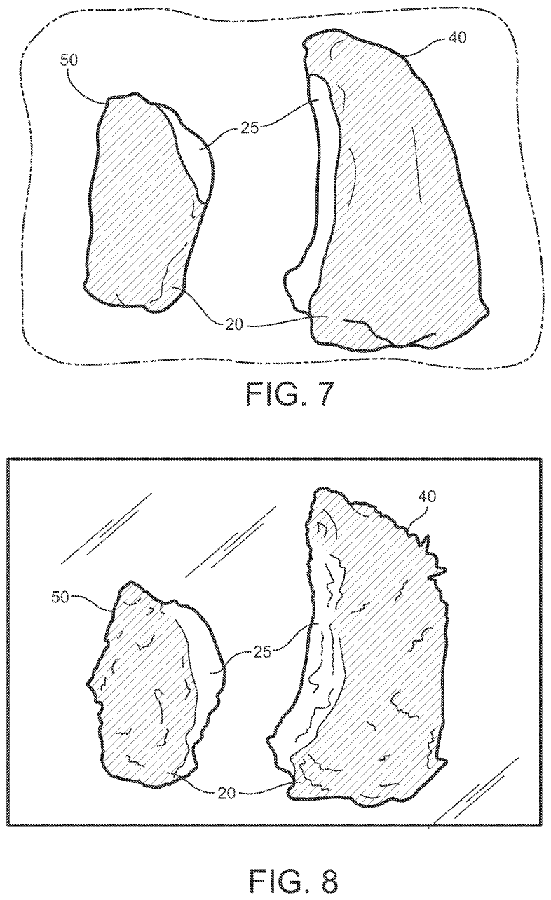

As shown in FIG. 7, after the skin-on bone-in thigh portion 40 and/or the skin-on boneless thigh portion 50 have been cooked to an internal temperature of at least about 120° F., the chicken thigh portions are then cooled at a temperature of at most about 40° F. for about an hour. The skin 20 of each of the skin-on bone-in thigh portion 40 and/or the skin-on boneless thigh portion 50 is maintained in a position such that it is substantially flat against the meat 25 of each thigh portion. In other embodiments, the thigh portions are cooled at a temperature of at most about 39° F., at most about 38° F., at most about 37° F., at most about 36° F., at most about 35° F., at most about 34° F., or at most about 33° F. In other embodiments, the thigh portions are cooled for about 30 minutes, for about 35 minutes, for about 40 minutes, for about 45 minutes, for about 50 minutes, for about 55 minutes, for about 60 minutes, for about 65 minutes, for about 70 minutes, for about 75 minutes, for about 80 minutes, for about 85 minutes, or for about 90 minutes.

Following the cooling step, the skin-on bone-in thigh portion 40 and/or the skin-on boneless thigh portion 50 are then fried to an internal temperature of at least 165° F. In other embodiments, the skin-on bone-in thigh portion 40 and/or the skin-on boneless thigh portion 50 are then fried to an internal temperature of at least about 166° F., at least about 167° F., at least about 168° F., at least about 169° F., or at least about 170° F. In other embodiments, the thigh portions are fried for several minutes, particularly at least about 120 seconds, at least about 125 seconds, at least about 130 seconds, at least, about 135 seconds, at least about 140 seconds, at least about 145 seconds, at least about 150 seconds, at least about 155 seconds, at least about 160 seconds, at least about 165 seconds, at least about 170 seconds, at least about 175 seconds, at least about 180 seconds, at least about 185 seconds, at least about 190 seconds, at least about 195 seconds, or at least about 200 seconds. In other embodiments, the step of frying the thigh portions comprises deep frying the thigh portions at about 350° F. As shown in FIG. 8, the skin-on bone-in thigh portion 40 and/or the skin-on boneless thigh portion 50 have been fried to produce wing-like poultry parts that approximate the texture and eating experience of traditional poultry wings with the enhanced flavor and juiciness of dark meat.

The resulting skin-on bone-in thigh portion 40 and/or the skin-on boneless thigh portion 50 may also be marinated, and/or battered/breaded, and/or coated with a suitable sauce such as barbecue sauce, if desired.

Accordingly, in one embodiment, a method for preparing thigh portion poultry products from a poultry thigh is provided, the method comprising the steps of: a) providing a poultry thigh 10 comprising skin 20, meat 25, and a generally centrally located bone 30; b) making one or more cuts substantially alongside and substantially parallel to the bone to produce a skin-on bone-in thigh portion 40 and a skin-on boneless thigh portion 50; c) preparing the skin-on bone-in thigh portion 40 and/or the skin-on boneless thigh portion 50 for cooking comprising flattening the skin 20 of each thigh portion against the meat 25 of each thigh portion; d) cooking the skin-on bone-in thigh portion 40 and/or the skin-on boneless thigh portion 50 to an internal temperature of at least about 120° F.; and e) cooling the skin-on bone-in thigh portion 40 and/or the skin-on boneless thigh portion 50 at a temperature of at most about 40° F. for between about 45 minutes and 75 minutes, wherein the skin 20 of each of the skin-on bone-in thigh portion 40 and/or the skin-on boneless thigh portion 50 is maintained in a position such that it is substantially flat against the meat 25 of each thigh portion. In another embodiment, the method further comprises the step of: f) frying the skin-on bone-in thigh portion 40 and/or the skin-on boneless thigh portion 50 to an internal temperature of at least 165° F. In a particular embodiment, step (f) comprises deep frying at about 350° F. for between about 120 seconds and about 180 seconds. In another particular embodiment, step (d) comprises baking at about 350° F. for about 50 minutes. In another particular embodiment, the poultry thigh 10 is a chicken thigh.

The method steps described herein that comprise cutting poultry thigh meat may be carried out by hand or by machine, using a knife (e.g., a Whizard® Trimmer knife), saw, or any other suitable cutting instrument or device known to those skilled in the art.

In another embodiment, a protein binding agent is used to adhere the skin 20 to the meat 25 of each thigh portion. As used herein, a protein binding agent is a compound that promotes the binding of proteins to each other. The binding may comprise covalent bonds, protein crosslinking, and/or non-covalent interactions such as hydrophobic interactions, ionic interactions, or hydrogen bonds. The protein binding agent may comprise one active ingredient, or may comprise a plurality of active ingredients. For example, in one embodiment, the agent may comprise collagen, fibrinogen, caseinate, whey protein, actomyosin, and/or thrombin. Additionally or alternatively, the protein binding agent may comprise a transglutaminase enzyme. In yet other embodiments, potato starch, functional poultry protein, functional pork protein, or functional soy protein may be used as part of the protein binding agent.

Another embodiment of the present invention provides a package (e.g., a container suitable for storing a food product) which contains the skin-on bone-in thigh portion 40 and/or the skin-on boneless thigh portion 50 from either before or after the frying step. The package may comprise a plurality of such skin-on bone-in thigh portions 40 and/or such skin-on boneless thigh portions 50 from either before or after the frying step. According to particular embodiments, the package further comprises a marinade enclosed within the package (e.g., a sauce, dressing, or seasoned liquid) which may contain oils, herbs, and/or spices to further flavor and/or tenderize the poultry product. According to another embodiment, the skin-on bone-in thigh portion 40 and/or the skin-on boneless thigh portion 50 from either before or after the frying step are substantially coated with breading. The package may further comprise one or more food products enclosed within the package, in addition to the skin-on bone-in thigh portion 40 and/or the skin-on boneless thigh portion 50 from either before or after the frying step (e.g., one or more additional portions of poultry meat which may or may not comprise thigh meat, such as one or more portions of breast meat).

Accordingly, in another embodiment, a skin-on bone-in thigh portion 40 and/or a skin-on boneless thigh portion 50 is provided produced by the method steps (a) through (e). In a further embodiment, a package is provided comprising at least one skin-on bone-in thigh portion 40 and/or at least one skin-on boneless thigh portion 50 produced by the method steps (a) through (e). In a particular embodiment, the package comprising at least one skin-on bone-in thigh portion 40 and/or at least one skin-on boneless thigh portion 50 produced by the method steps (a) through (e) further comprises a marinade.

In another embodiment, a breaded skin-on bone-in thigh portion and/or a skin-on boneless thigh portion is provided, wherein a bone-in thigh portion 40 and/or a skin-on boneless thigh portion 50 produced by the method steps (a) through (e) is substantially coated in breading. In a further embodiment, a package is provided comprising at least one breaded skin-on bone-in thigh portion and/or at least one breaded skin-on boneless thigh portion produced by the method steps (a) through (e).

In another embodiment, a skin-on bone-in thigh portion 40 and/or a skin-on boneless thigh portion 50 is provided produced by the method steps (a) through (f). In a further embodiment, a package is provided comprising at least one skin-on bone-in thigh portion 40 and/or at least one skin-on boneless thigh portion 50 produced by the method steps (a) through (f).

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

What is claimed is:

1. A method for preparing thigh portion poultry products from a poultry thigh, the method comprising the steps of:
a. providing a poultry thigh comprising skin, meat, and a generally centrally located bone;
b. making one or more cuts substantially alongside and substantially parallel to the bone to produce a skin-on bone-in thigh portion and a skin-on boneless thigh portion;
c. preparing the skin-on bone-in thigh portion and/or the skin-on boneless thigh portion for cooking comprising flattening the skin of each thigh portion against the meat of each thigh portion;
d. cooking the skin-on bone-in thigh portion and/or the skin-on boneless thigh portion to an internal temperature of at least about 120° F.; and
e. cooling the skin-on bone-in thigh portion and/or the skin-on boneless thigh portion at a temperature of at most about 40° F. for between about 45 minutes and 75 minutes, wherein the skin of each of the skin-on bone-in thigh portion and/or the skin-on boneless thigh portion is maintained in a position such that it is substantially flat against the meat of each thigh portion.

2. The method of claim 1, further comprising the step of:
f. frying the skin-on bone-in thigh portion and/or the skin-on boneless thigh portion to an internal temperature of at least 165° F.

3. The method of claim 2, wherein step (f) comprises deep frying at about 350° F. for between about 120 seconds and about 180 seconds.

4. The method of any of claims 1 to 3, wherein step (d) comprises baking at about 350° F. for about 50 minutes.

5. The method of any of claims 1 to 4, wherein the poultry thigh is a chicken thigh.

6. A skin-on bone-in thigh portion produced by the method of claim 1.

7. A skin-on boneless thigh portion produced by the method of claim 1.

8. A package comprising at least one skin-on bone-in thigh portion of claim 6 and/or at least one skin-on boneless thigh portion of claim 7.

9. The package according to claim 8, wherein the package further comprises a marinade.

10. A breaded skin-on bone-in thigh portion comprising the bone-in thigh portion of claim 6 substantially coated in breading.

11. A breaded skin-on boneless thigh portion comprising the boneless thigh portion of claim 7 substantially coated in breading.

12. A package comprising at least one breaded skin-on bone-in thigh portion of claim 10 and/or at least one breaded skin-on boneless thigh portion of claim 11.

13. A skin-on bone-in thigh portion produced by the method of claim 2.

14. A skin-on boneless thigh portion produced by the method of claim 2.

15. A package comprising at least one skin-on bone-in thigh portion of claim 13 and/or at least one skin-on boneless thigh portion of claim 14.
